(19) United States
(12) Patent Application Publication
(10) Pub. No.: US 2020/0051050 A1
(43) Pub. Date: Feb. 13, 2020

(54) METHODS AND SYSTEMS FOR ENABLING DATA EXCHANGE BETWEEN COMPUTING DEVICES LACKING A SHARED DATA EXCHANGE PROTOCOL

(71) Applicant: MASTERCARD INTERNATIONAL INCORPORATED, Purchase, NY (US)

(72) Inventors: Alexander A. Liu, New York, NY (US); Ronald C. Hynes, Ridgefield, CT (US)

(21) Appl. No.: 16/657,835

(22) Filed: Oct. 18, 2019

Related U.S. Application Data
(63) Continuation of application No. 12/342,887, filed on Dec. 23, 2008, now abandoned.

(51) Int. Cl. G06Q 20/14; G06Q 20/10; G06Q 20/40; G06Q 30/04

(52) U.S. Cl. CPC G06Q 20/14; G06Q 20/105; G06Q 20/10; G06Q 30/04; G06Q 20/102; G06Q 20/40

(57) ABSTRACT

A computer-based method for paying a bill using a transaction card account is performed using an interchange computer coupled to a memory. The method includes submitting bill pay data by a consumer for processing by a bill payment outsourcer, receiving the bill pay data and an authorization message, processing the bill pay data and the authorization message for transmission to an issuer associated with the transaction card, and receiving an approval message from the issuer after the issuer has confirmed that the transaction card account includes sufficient funds to pay the submitted bill. The approval message is provided to the bill payment outsourcer. Funds data representing a transfer of funds from the transaction card account is transmitted to the biller for paying the bill.

### BACKGROUND OF THE INVENTION

The field of the invention relates generally to paying bills using a transaction card account and, more particularly, to network-based systems and methods for paying a bill using a prepaid transaction card account or a debit card account.

At least some known financial institutions issue prepaid transaction cards or debit cards to consumers. Such banks are also known as “issuer banks” or “issuers.” Prepaid transaction cards and debit cards have an account associated therewith at the issuer bank. At least some users of prepaid transaction cards are underbanked or unbanked consumers and, as such, may not have a checking account with which to write personal checks to pay bills, such as utility bills, rent, and/or car payments. Such consumers may use cash, money orders, and/or Cashier's checks to pay their bills instead of using a personal check.

Some known issuer banks offer prepaid card users the ability to pay bills using the account associated with the prepaid transaction card. As such, prepaid card users can pay bills using funds within the account associated with the prepaid card rather than resorting to money orders and/or Cashier's checks to pay bills. Issuer banks providing such a service typically contract with a bill payment outsourcer for bill pay services. In working with a bill payment outsourcer, the issuer bank uses an issuer processor that must be integrated with the bill payment outsourcer such that data transmitted and funds transferred between the bill payment outsourcer and the issuer processor are in the correct format and have the correct connectivity so that these two parties are able to communicate with one another. Such common formatting and connectivity is referred to herein as an integration protocol. For each issuer/issuer processor that the bill payment outsourcer contracts with, an integration protocol must be established between the bill payment outsourcer and the issuer processor. However, such an integration protocol may cost upwards of $50,000 (U.S.) and takes at least three months to establish. Further, if the issuer bank would like to change bill payment outsourcers, a new integration protocol is required to be developed and established.

For example, FIG. 1 shows a schematic diagram illustrating a known multi-party system for paying bills using a prepaid transaction card. The system shown in FIG. 1 includes an interface, such as an online banking web site, a bill payment outsourcer (BPO), an issuer bank having an issuer processor, also referred to herein as “issuer/issuer processor,” a remote payment and presentment system (RPPS), and a biller. The remote payment and presentment system (RPPS) may include, by way of example, a system known as the Remote Payment and Presentment Service (RPPS®) (MasterCard RPPS and RPPS are registered trademarks of MasterCard International Incorporated located in Purchase, N.Y.). The web site is hosted by the issuer/issuer processor and/or the BPO. A prepaid card user accesses the web site to pay a bill using a prepaid transaction card account held by the issuer. Using the web site, the user submits information regarding the bill to be paid and/or the biller. Such information is referred to herein as “bill pay data.” Bill pay data includes at least data representing a bill to be paid by the user including a bill amount and a transaction card account associated with the user including an account identifier, an account number, and/or a cardholder name for the card. The bill pay data is transmitted via the web site to BPO.

Once the BPO receives the bill pay data, the BPO communicates with the issuer/issuer processor using an integration protocol, as described above. Through the integration protocol, the BPO checks a balance of funds within the consumer's prepaid account and puts a hold on the necessary funds included within the account to ensure that sufficient funds are available to pay the bill. As stated above, the integration protocol that is required between the BPO and the issuer processor is expensive and time consuming to establish.

When the consumer's account at the issuer bank has sufficient funds to pay the bill, the BPO transmits the bill pay data to RPPS, and the RPPS transmits the bill pay data to the biller. After the funds have been held or reserved in the user's account at the issuer bank and during the settlement process, the issuer bank transmits funds data to the RPPS via the issuer processor. As used herein, the term “funds data” refers to data representing a transfer of funds from one account to another account. The RPPS transmits the funds to the biller to pay the bill. Alternatively, the bill payment outsourcer may write a check to the biller once the bill payment outsourcer has received the funds from the issuer processor.

Accordingly, there is a need for a system through which a bill payment outsourcer and an issuer processor can transfer transaction data without having to establish an integration protocol between a bill payment outsourcer and an issuer processor. Further, there is a need for a system that enables an issuer bank to change bill payment outsourcers without having to develop a new integration protocol.

### BRIEF DESCRIPTION OF THE INVENTION

In one aspect, a computer-based method for paying a bill using a transaction card account is provided. The method is performed using an interchange computer coupled to a memory. The method includes submitting bill pay data by a consumer for processing by a bill payment outsourcer. The bill pay data includes data representing the bill to be paid to a biller and the transaction card account associated with the consumer to be used for paying the bill. The method further includes receiving the bill pay data and an authorization message at the interchange computer for storage within the memory, wherein the authorization message requests an approval message confirming that the transaction card account includes sufficient funds to pay the submitted bill, processing the bill pay data and the authorization message for transmission to an issuer associated with the transaction card, and receiving at the interchange computer the approval message from the issuer after the issuer has confirmed that the transaction card account includes sufficient funds to pay the submitted bill. The approval message is provided to the bill payment outsourcer. Funds data representing a transfer of funds from the transaction card account is transmitted to the biller for paying the bill.

In another aspect, a computer for processing a bill payment by a consumer using a transaction card account is provided. The computer is coupled to a database. The computer is configured to receive bill pay data and an authorization message for storage within the database, wherein the bill pay data is submitted by the consumer for processing by a bill payment outsourcer. The bill pay data includes data representing the bill to be paid to a biller and the transaction card account associated with the consumer to be used to pay the bill, and the authorization message requests an approval message confirming that the transaction card account includes sufficient funds to pay the submitted bill. The computer is configured to process the bill pay data and the authorization message for transmission to an issuer associated with the transaction card, receive the approval message from the issuer after the issuer has confirmed that the transaction card account includes sufficient funds to pay the submitted bill, wherein the approval message is provided to the bill payment outsourcer, and transmit funds data representing a transfer of funds from the transaction card account to the biller for paying the bill.

In still another aspect, a network based system for paying a bill using a transaction card account is provided. The system includes a first computer associated with an acquirer processor and a bill payment outsourcer, a second computer associated with an issuer processor and an issuer holding the transaction card account, and an interchange server system coupled a database. The interchange server system is further coupled to the first computer and the second computer. The interchange server system is configured to receive bill pay data and an authorization message for storage within the database, wherein the bill pay data is submitted by the consumer for processing by the first computer. The bill pay data includes data representing the bill to be paid to a biller and the transaction card account associated with the consumer to be used to pay the bill, and the authorization message requests an approval message confirming that the transaction card account includes sufficient funds to pay the submitted bill. The interchange server system is further configured to process the bill pay data and the authorization message for transmission to the second computer, receive the approval message from the second computer after the second computer has confirmed that the transaction card account includes sufficient funds to pay the submitted bill, wherein the approval message is provided to the first computer, and transmit funds data representing a transfer of funds from the transaction card account to the biller for paying the bill.

In still another aspect, a computer program embodied on a computer readable medium for paying a bill using a transaction card account is provided. The program includes at least one code segment that submits bill pay data by a consumer for processing by a bill payment outsourcer. The bill pay data includes data representing the bill to be paid to a biller and the transaction card account associated with the consumer to be used for paying the bill. The at least one code segment further receives the bill pay data and an authorization message for storage within a memory, wherein the authorization message requests an approval message confirming that the transaction card account includes sufficient funds to pay the submitted bill, processes the bill pay data and the authorization message for transmission to an issuer associated with the transaction card, and receives the approval message from the issuer after the issuer has confirmed that the transaction card account includes sufficient funds to pay the submitted bill. The approval message provided to the bill payment outsourcer. The at least one code segment transmits funds data representing a transfer of funds from the transaction card account to the biller for paying the bill.

The embodiments described herein facilitate communication of transaction data between a bill payment outsourcer and an issuer bank. The systems and method described herein include an interchange computer and/or network in communication with an issuer processor and an acquirer processor to transfer message and/or funds between parties to a transaction, as compared to including an integration protocol between a bill payment outsourcer and the issuer processor.

### BRIEF DESCRIPTION OF THE DRAWINGS

FIG. 1 is a schematic diagram illustrating a known multi-party system for paying bills using a prepaid transaction card.

FIG. 2 is a schematic diagram illustrating an exemplary multi-party payment card industry system for enabling ordinary payment-by-card transactions in which the merchants and issuer do not need to have a one-to-one special relationship.

FIG. 3 is a simplified block diagram of an exemplary embodiment of a server architecture of a system in accordance with one embodiment of the present invention.

FIG. 4 is an expanded block diagram of an exemplary embodiment of a server architecture of a system in accordance with one embodiment of the present invention.

FIG. 5 is a schematic diagram illustrating an exemplary multi-party system for paying a bill using a prepaid transaction card in accordance with one embodiment of the present invention.

FIG. 6 is a flowchart illustrating an exemplary method utilized by the system shown in FIG. 5 for paying a bill using a prepaid transaction card.

### DETAILED DESCRIPTION OF THE INVENTION

The embodiments described herein are directed to systems and methods for paying bills using transaction cards, such as a credit card, debit card, membership cards, promotional cards, frequent flyer cards, identification cards, prepaid cards, gift cards, and/or any other devices that may hold payment account information, such as mobile phones, personal digital assistants (PDAs), and key fobs. Such cards and/or devices are referred to herein as “a card” or “cards.” These cards can all be used as a method of payment for performing a transaction. For example, a transaction card franchiser, transaction card provider, bank, and/or credit union may capture and store purchasing data for account holders. A subset of such cards is referred to as “prepaid transaction cards” or “prepaid cards.” Examples of prepaid cards include any card for which money is deposited into an account and the card is used to withdraw money from that account. Prepaid card transactions are processed using an interchange network, as described in more detail below. As described herein, the systems and methods pay bills using a prepaid transaction card. However, it is understood that the systems and methods described herein could also be used to pay bills using other transaction cards such as credit cards and/or debit cards.

As used herein, the remote payment and presentment system (RPPS) includes any remote computer system capable of processing an electronic bill payment such as, by way of example, a system known as the Remote Payment and Presentment Service (RPPS®) (MasterCard RPPS and RPPS are registered trademarks of MasterCard International Incorporated located in Purchase, N.Y.). The “RPPS®” (Remote Payment and Presentment Service) refers to a service or system for processing an electronic bill payment. More specifically, an RRPS® service and/or system is a computerized bill payment system for electronically processing a financial transaction to affect bill payment. The financial transactions processed by RPPS® system include, without limitation, bill and/or invoice presentment, bill and/or invoice payment, investment services, person-to-person payments, transmissions of financial information, home banking transactions, and purchase transactions. The RRPS® system conventionally maintains a central repository of information relating to services and transactions performed and/or facilitated and disseminates portions of this information to and between respective participants in a network, including those associated with user network stations as well as other participants in the network. In providing and/or facilitating some electronic financial services, the RPPS® system causes funds and/or funds data to move among and between deposit accounts associated with various ones of the network users and a deposit account associated with the RPPS® system maintained at a financial institution. Additionally, other types of accounts are often used to move funds and/or funds data, such as stored value accounts and credit accounts.

Further, two or more user network stations can communicate with one another via the RPPS® system. For example, user network stations communicate with one another via communication links, with the communications traveling through the RPPS® system. The communications between the user network stations are often the basis of the financial transactions and/or services performed or facilitated by the RPPS® system. These communications include data relating to the transaction, such as, invoices, account data, funds data, bill pay data, purchase agreements, investment agreements, as well as other agreements relating to financial matters. It should also be noted that communications between network users not made via the user network stations can also be the basis of the financial transactions and/or services performed or facilitated by the RPPS® system. Network users include, but are not limited to, individuals, businesses, educational institutions, and other organizations.

Although the RPPS® system is described herein, the systems and processes described herein are not limited to using the RPPS® system but may utilize any remote payment and presentment system (RPPS). Accordingly, the term “RPPS” is used herein to include both the RPPS® system and any other remote payment and presentment system.

The systems and processes described herein enable a user to deposit money into a prepaid card account and access the money in the prepaid card account to electronically pay bills, such as utility bills, car loan payments, mortgage payments, rent, and/or other bills that a user may use a personal check, money order, and/or cash to pay. In an alternative embodiment, the systems and processes described herein enable a user to use a debit card to electronically pay bills instead of using a personal check, money order or cash. A technical effect of the systems and processes described herein include at least one of (a) submitting bill pay data to a bill payment outsourcer by a user using a user interface such as an online banking web site, wherein the bill pay data includes data representing a bill to be paid by the user including a bill amount which may include an additional cardholder fee, and a transaction card associated with the user including an account, an account number and a cardholder name for the card, wherein the transaction card is a prepaid card or a debit card; (b) transmitting an authorization message relating to the submitted bill pay data from an acquirer processor associated with the bill payment outsourcer to an issuer processor via an interchange network, wherein the transaction card account is accessible by the issuer processor; (c) determining by the issuer processor whether the user has the necessary funds within the account associated with the transaction card to pay the bill amount including any additional cardholder fee; (d) if the user has the necessary funds, reserving a reserve amount within the account by the issuer processor, wherein the reserve amount equals the bill amount and is reserved for paying the bill during a settlement process; (e) if the user has the necessary funds, transmitting an approval message relating to the submitted bill pay data from the issuer processor to the bill payment outsourcer via an interchange network; (f) transmitting the bill pay data from the bill payment outsourcer to a remote payment and presentment system for processing and further transmitting to a biller associated with the bill being paid; (g) after transmitting the bill pay data to the biller, transferring funds data including the reserve amount from the issuer processor through the network interchange to the bill payment outsourcer; (h) transferring the funds data from the bill payment outsourcer to the remote payment and presentment system for processing; and (i) transferring the funds data from the remote payment and presentment system to the biller in order to complete the payment of the bill, wherein any additional cardholder fee charged is not transferred to the biller but rather is retained by the network interchange. In an alternative embodiment, the funds data are transferred directly from the issuer processor or the network interchange to the remote payment system for ultimate payment to the biller.

In the case where the user does not have the necessary funds included with the account associated with the transaction card, the issuer processor does not transmit an approval message to the bill payment outsourcer through the network interchange, nor does the issuer processor reserve the reserve amount. Rather, the issuer processor transmits a rejection or denial message to the bill payment outsourcer and/or to the user interface being used by the user. The rejection or denial message advises the user and the bill payment outsourcer that the user has inadequate funds in the account to cover the bill being paid. Thus, the attempt to pay the bill is rejected by the system and the transaction is ended.

By using an interchange network to communicate between the bill payment outsourcer and the issuer bank, the system and method described herein treat the bill payment outsourcer as any other merchant, which does not require any new communication protocols to be implemented between the bill payment outsourcer and the issuer bank. As such, the embodiments described herein facilitate reducing the upfront costs incurred by an issuer bank wishing to provide bill paying services to its transaction card users, such as prepaid transaction card holders.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T, New York, N.Y.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

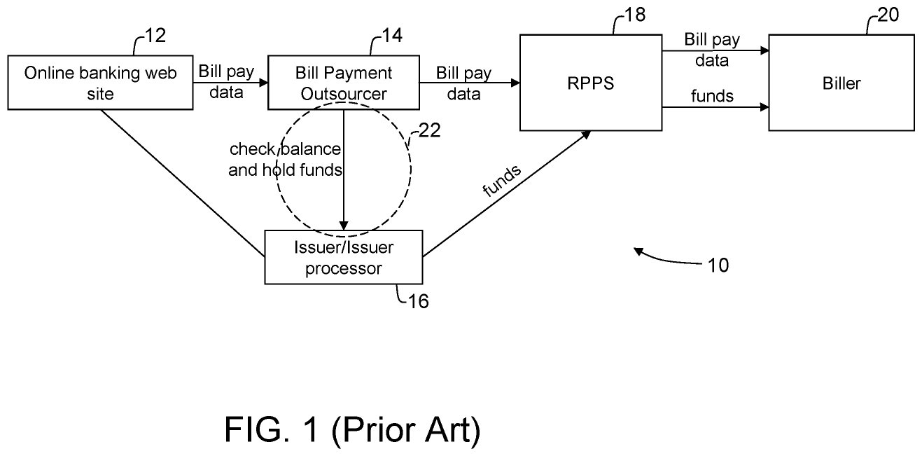

FIG. 1 shows a schematic diagram illustrating a known multi-party system 10 for paying bills using a prepaid transaction card. System 10 includes an interface, such as an online banking website 12, a bill payment outsourcer (BPO) 14, an issuer bank having an issuer processor 16, also referred to herein as “issuer/issuer processor,” a remote presentment and payment system or an RPPS 18, as described in more detail below, and a biller 20. Web site 12 is hosted by issuer/issuer processor 16 and/or BPO 14. A prepaid card user accesses web site 12 to pay a bill using a prepaid transaction card account held by issuer 16. Using web site 12, the user submits information regard the bill to be paid and/or biller 20. Such information is referred to herein as “bill pay data,” as described in more detail above. The bill pay data is transmitted via web site 12 to BPO 14.

Once BPO 14 receives the bill pay data, BPO 14 communicates with issuer/issuer processor via an integration protocol 22, as described above. Through the integration protocol 22, BPO 14 checks a balance of funds within the consumer's prepaid account and puts a hold on funds within the account to ensure that sufficient funds are available to pay the bill. When the consumer's account at issuer bank 16 has sufficient funds to pay the bill, BPO 14 transmits the bill pay data to RPPS 18, and RPPS 18 transmits the bill pay data to biller 20. After funds have been held in the user's account at issuer bank 16, issuer bank 16 transmits funds data related to the held funds to RPPS 18 via issuer processor 16. RPPS 18 transmits the funds data to biller 20 to pay the bill. Alternatively, the bill payment outsourcer may write a check to the biller once the bill payment outsourcer has received the funds data from the issuer processor.

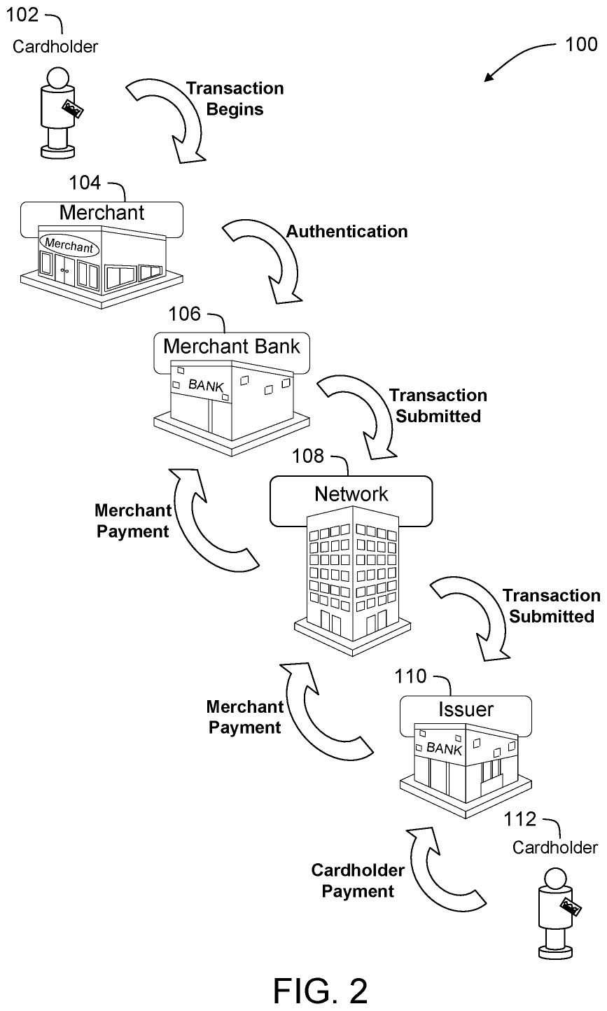

FIG. 2 is a schematic diagram illustrating an exemplary multi-party payment card industry system 100 for enabling ordinary payment-by-card transactions in which the merchants 104 and issuer 110 do not need to have a one-to-one special relationship. The present invention relates to a payment card system, such as a credit card payment system using the MasterCard® interchange network. The MasterCard® interchange network is a set of proprietary communications standards promulgated by MasterCard International Incorporated® for the exchange of financial transaction data and settlement funds between financial institutions that are members of MasterCard International Incorporated®. (MasterCard International Incorporated is a registered trademark of MasterCard International Incorporated located in Purchase, N.Y.).

In a typical payment card system, a financial institution called the “issuer” issues a payment card, such as a prepaid card, to a consumer 102, who uses the card to tender payment for a purchase from a merchant 104. To accept payment with the card, the merchant 104 must normally establish an account with a financial institution 106 that is part of the financial payment system. This financial institution is usually called the “merchant bank,” the “acquiring bank,” the “acquirer bank,” and/or the “acquirer.” When a consumer 102 tenders payment for a purchase with a transaction card, the merchant 104 requests authorization from the merchant bank 106 for the amount of the purchase. The request may be performed over the telephone or Internet, but is usually performed through the use of a point-of-sale terminal, which reads the consumer's account information from the magnetic stripe or chip on the transaction card and communicates electronically with the transaction processing computers of the merchant bank 106. Alternatively, a merchant bank 106 may authorize a third party to perform transaction processing on its behalf. In this case, the point-of-sale terminal will be configured to communicate with the third party. Such a third party is usually called a “merchant processor,” an “acquiring processor,” an “acquirer processor,” and/or a “third party processor.”

Using the interchange network 108, the computers of the merchant bank 106 or the merchant processor will communicate with the computers of the issuer bank 110 to determine whether the consumer's account 112 is in good standing and whether the purchase is covered by the consumer's available credit line or account balance. When a prepaid transaction card is used, the computers of the merchant bank 106 or the merchant processor will communicate with the computers of the issuer bank 110 to determine whether the consumer's account 112 has funds therein that cover the amount of the transaction. Based on these determinations, the request for authorization will be declined or accepted. If the request is accepted, an authorization code is issued to the merchant 104. When a prepaid transaction card is used, funds within the consumer's account 112 are verified and held for payment of the transaction. Such funds are referred to herein as “held funds,” and/or a “reserve amount.” The reserve amount equals the amount to be paid for the transaction.

When a request for authorization is accepted, the available credit line and/or balance of consumer's account 112 is decreased. Normally, a charge for a credit transaction is not posted immediately to a consumer's account 112 because bankcard associations, such as MasterCard International Incorporated®, have promulgated rules that do not allow a merchant 104 to charge, or “capture,” a transaction until goods are shipped or services are delivered. However, with respect to at least some debit and/or prepaid card transactions, a charge may be posted at the time of the transaction and/or a hold may be put on funds within the account until funds are settled between parties to the transaction. When a merchant 104 ships or delivers the goods or services, the merchant 104 captures the transaction by, for example, appropriate data entry procedures on the point-of-sale terminal. This may include bundling of approved transactions daily for standard retail purchases. If a consumer 102 cancels a transaction before it is captured, a “void” is generated. If a consumer 102 returns goods after the transaction has been captured, a “credit” is generated.

After a transaction is captured, the transaction is settled between the merchant 104, the merchant bank 106, and the issuer 110. Settlement refers to the transfer of financial data or funds between the merchant's account, the merchant bank 106, and the issuer 110 related to the transaction. Usually, transactions are captured and accumulated into a “batch,” which are settled as a group during a settlement process, as described in more detail below. More specifically, during an exemplary settlement process, a transaction is typically settled between the issuer 110 and the interchange network 108, and then between the interchange network 108 and the merchant bank 106, and then between the merchant bank 106 and the merchant 104. In the exemplary embodiment, “debit entries” and “credit entries” are applied to the transaction and entries are transmitted to appropriate parties. For example, based on all transactions occurring for each party to the transaction between settlements, debit entries are applied to accounts that have a negative overall change in the amount of funds held therein, and credit entries are applied to accounts that have a positive overall change in the amount of funds held therein. As such, accounts that should have less money than they had at the last settlement incur debit entries, and accounts that should have more money than they had at the last settlement incur credit entries.

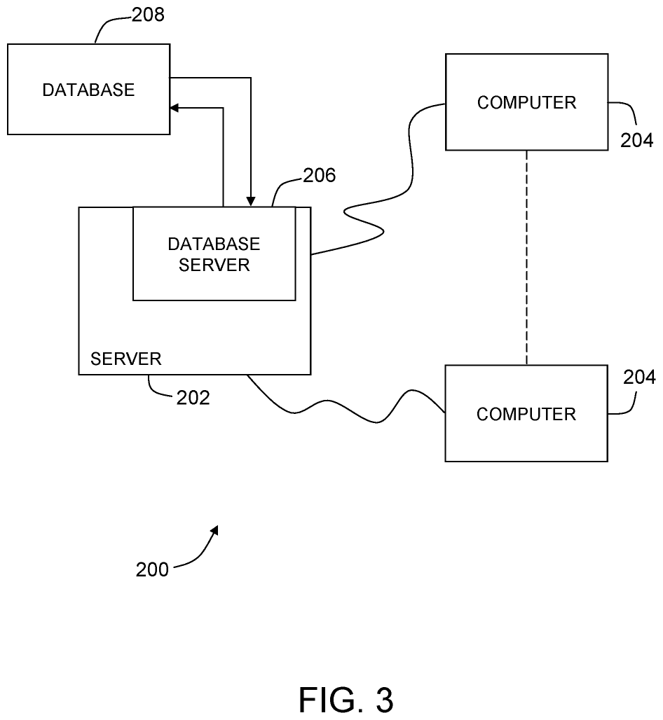

FIG. 3 is a simplified block diagram of an exemplary system 200 in accordance with one embodiment of the present invention. In one embodiment, system 200 is a payment card system used for predicting consumer behavior, and is operable to implement the modeling techniques and transaction database described herein. In addition, system 200 is operable as a payment card system, which can be utilized by users for management of accounts and payment transactions.

More specifically, in the example embodiment, system 200 includes a server system 202, and a plurality of client sub-systems, also referred to as client systems 204, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) or a wide area network (WAN), dial-in-connections, cable modems and special high-speed ISDN lines. Client systems 204 could be any device capable of interconnecting to the Internet including a web-based phone, personal digital assistant (PDA), or other web-based connectable equipment. A database server 206 is connected to a database 208 containing information on a variety of matters, as described below in greater detail.

In one embodiment, centralized database 208 is stored on server system 202 and can be accessed by potential users at one of client systems 204 by logging onto server system 202 through one of client systems 204. In an alternative embodiment, database 208 is stored remotely from server system 202 and may be non-centralized. Database 208 stores transaction data generated as part of sales activities conducted over the bankcard network including, but not limited to, data relating to merchants, account holders or customers, purchases, a name of a cardholder, an account number, a transaction history, and other cardholder-related information.

In the example embodiment, server system 202 may be associated with a network interchange, and may be referred to as an interchange computer system. Server system 202 may be used for processing transaction data. In addition, client systems 204 may include a computer system associated with at least one of an online bank, a bill payment outsourcer, an acquirer bank, an acquirer processor, an issuer bank associated with a transaction card, an issuer processor, a remote payment system and a biller. Accordingly, each party involved in processing transaction data are associated with a computer system shown in system 200 such that the parties can communicate with one another as described herein.

The embodiments illustrated and described herein as well as embodiments not specifically described herein but within the scope of aspects of the invention constitute exemplary means for paying a bill using a transaction card account, and more particularly, constitute exemplary means for paying a bill using a prepaid account associated with a transaction card via at least an interchange network. For example, the server system 202 or the client system 204, or any other similar computer device, programmed with computer-executable instructions to execute processes and techniques as described herein, constitutes exemplary means for paying a bill using a transaction card from an account associated with the transaction card.

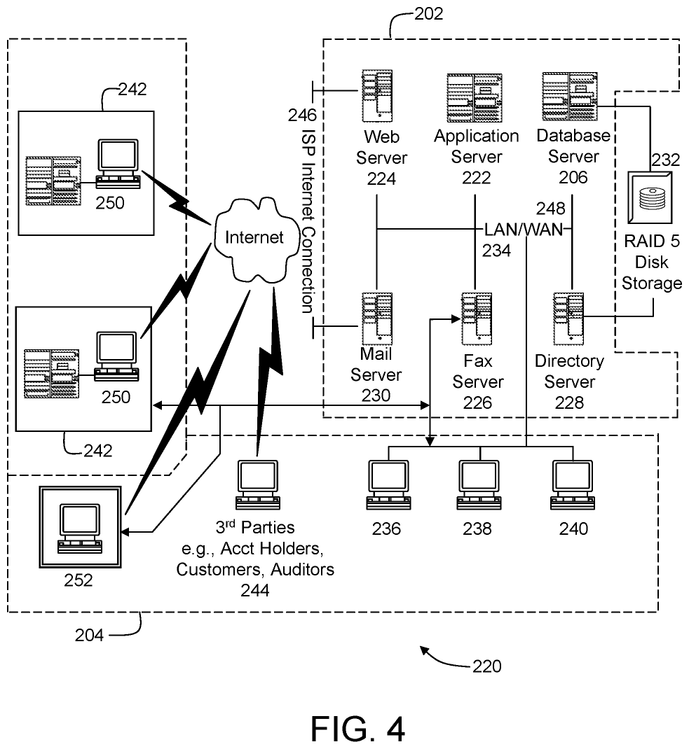

FIG. 4 is an expanded block diagram of an exemplary embodiment of a server architecture of a system 220 in accordance with one embodiment of the present invention. Components in system 220, identical to components of system 200 (shown in FIG. 3), are identified in FIG. 4 using the same reference numerals as used in FIG. 3. System 220 includes server system 202 and client systems 204. Server system 202 further includes database server 206, an application server 222, a web server 224, a fax server 226, a directory server 228, and a mail server 230. A disk storage unit 232 is coupled to database server 206 and directory server 228. Servers 206, 222, 224, 226, 228, and 230 are coupled in a local area network (LAN) 234. In addition, a system administrator's workstation 236, a user workstation 238, and a supervisor's workstation 240 are coupled to LAN 234. Alternatively, workstations 236, 238, and 240 are coupled to LAN 234 using an Internet link or are connected through an Intranet.

Each workstation 236, 238, and 240 is a personal computer having a web browser. Although the functions performed at the workstations typically are illustrated as being performed at respective workstations 236, 238, and 240, such functions can be performed at one of many personal computers coupled to LAN 234. Workstations 236, 238, and 240 are illustrated as being associated with separate functions only to facilitate an understanding of the different types of functions that can be performed by individuals having access to LAN 234.

Server system 202 is configured to be communicatively coupled to various individuals, including employees 242 and to third parties, e.g., account holders, customers, auditors, etc., 244 using an ISP Internet connection 246. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 248, local area network 234 could be used in place of WAN 248.

In the exemplary embodiment, any authorized individual having a workstation 250 can access system 220. At least one of the client systems includes a manager workstation 252 located at a remote location. Workstations 250 and 252 are personal computers having a web browser. Also, workstations 250 and 252 are configured to communicate with server system 202. Furthermore, fax server 226 communicates with remotely located client systems, including a client system 252 using a telephone link. Fax server 226 is configured to communicate with other client systems 236, 238, and 240 as well.

In the example embodiment, workstations 236, 238, and 240 may be associated with at least one of an online bank, a bill payment outsourcer, an acquirer bank, an acquirer processor, an issuer bank associated with a transaction card, an issuer processor, a remote payment system and a biller.

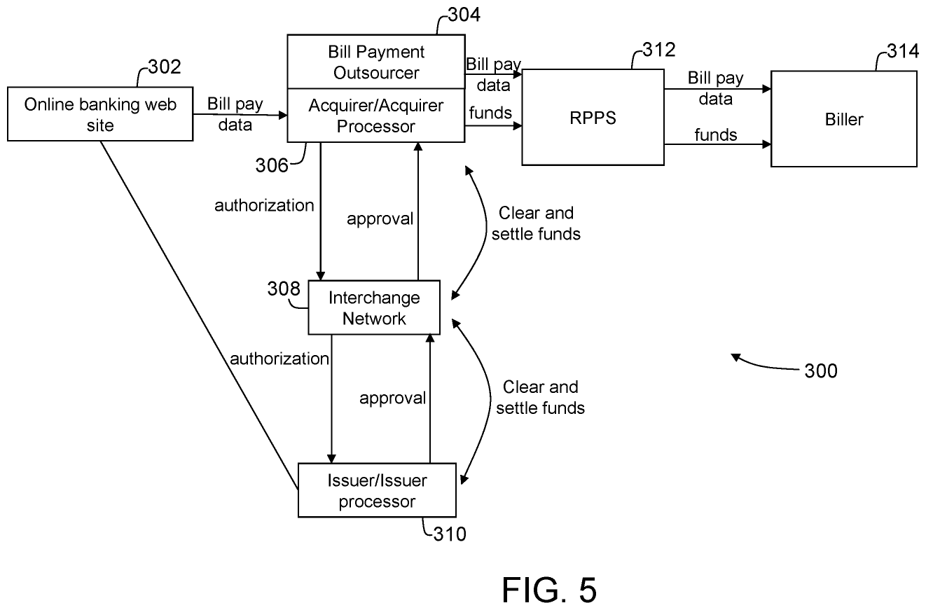

FIG. 5 shows a schematic diagram illustrating an exemplary multi-party system 300 for paying a bill using a prepaid transaction card. System 300 can be implemented using system 200 (shown in FIG. 3) and/or system 220 (shown in FIG. 4). A user of the prepaid transaction card is referred to herein as a “prepaid card user” or a “prepaid card consumer.” System 300 generally treats a bill payment outsourcer similarly to merchant 104 (shown in FIG. 2) in system 100 (shown in FIG. 2). More specifically, bill pay transactions are processed as if the bill payment outsourcer is a merchant, and the funds data received by the bill payment outsourcer are then transferred to a biller of the prepaid card user to pay a bill.

System 300 includes an interface, such as a web site 302, a bill payment outsourcer (BPO) 304, an acquirer bank/acquirer processor 306, also referred to herein as “acquirer/acquirer processor,” an interchange network 308, an issuer/issuer processor 310, a remote payment and presentment system or RPPS 312, and a biller 314. In the exemplary embodiment, acquirer/acquirer processor 306 includes acquirer bank 106 (shown in FIG. 2) having integrated therewith an acquirer processor configured to communicate with interchange network 308 and RPPS 312. BPO 304 and acquirer/acquirer processor 306 are associated with a first remote computer system, such as client system 204 (shown in FIG. 3). Further, issuer/issuer processor 310 includes issuer bank 110 (shown in FIG. 2) having integrated therewith an issuer processor configured to communicate with interchange network 308 and RPPS 312. Issuer/issuer processor 310 is associated with a second remote computer system, such as client system 204. Interchange network 308 is associated with a computer system, such as server system 202 (shown in FIG. 3). RRPS 312 is, in the exemplary embodiment, also associated with a payment computer system, such as client system 204 or, alternatively, as part of server system 202. In the exemplary embodiment, acquirer processor and/or issuer processor are companies that are separate from acquirer bank 106 and issuer bank 110, respectively. Alternatively, acquirer processor may be the same company as acquirer bank 106, and/or issuer processor may be the same company as issuer bank 110.

In the exemplary embodiment, interchange network 308 is interchange network 108 (shown in FIG. 2), and RPPS 312 is controlled by interchange network 308. Alternatively, interchange network 308 and RPPS 312 may be separately controlled systems. Further, rather than using RPPS 312, any suitable funds and data transfer network may be used with system 300. In the exemplary embodiment, biller 314 is any creditor of a prepaid card user that issues bills to the prepaid card consumer. For example, biller 314 may be a utility company, a loan holder, a landlord, and/or any other suitable biller. Web site 302 is, in the exemplary embodiment, hosted by issuer/issuer processor 310 and/or BPO 304. Alternatively, web site 302 is hosted by a third party, and the third party is in communication with BPO 304 and/or issuer/issuer processor 310. As an alternative to web site 302, a prepaid consumer can transmit bill pay data to BPO 304 via an interactive voice response (IVR) system and/or any other suitable interface.

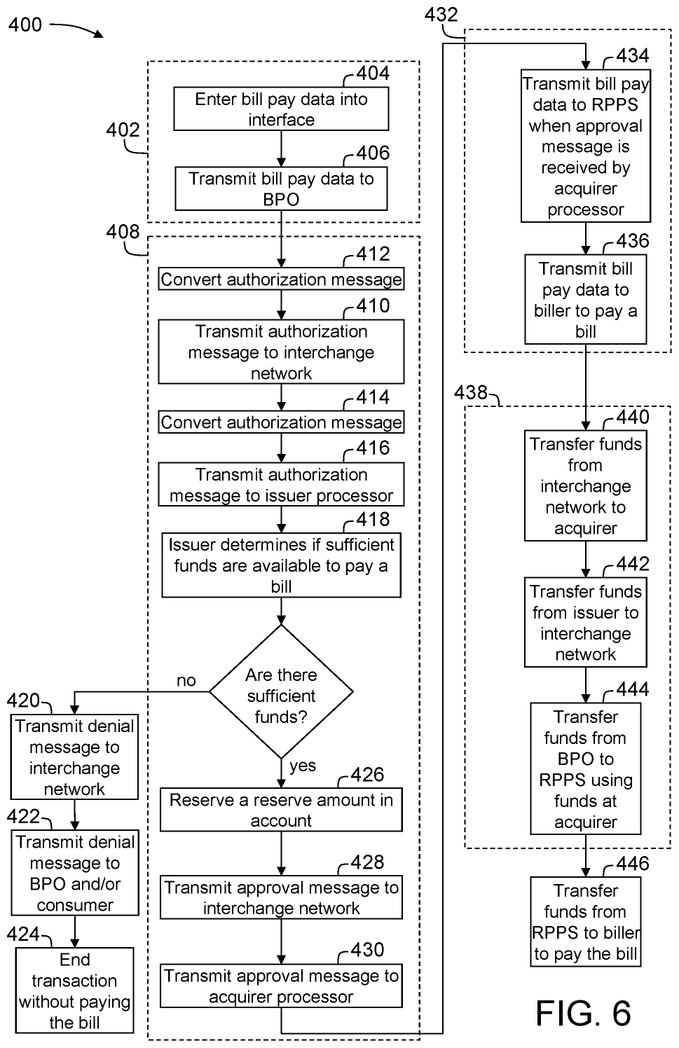

To acquire a prepaid transaction card, a consumer deposits funds in a prepaid card account held by issuer bank 110. Issuer bank 110 issues a prepaid transaction card to the consumer. The consumer may spend the deposited funds, less any fees, using the prepaid transaction card as described above with respect to FIG. 2. To use the deposited funds to pay a bill issued to the prepaid consumer from biller 314, an exemplary method 400 for paying bills using the prepaid transaction card is performed using system 300. FIG. 6 shows a flowchart illustrating method 400 for paying a bill using the prepaid transaction card and account associated therewith.

Referring to FIGS. 5 and 6, to pay a bill, the prepaid card user accesses web site 302 and/or any other suitable interface, such as the IVR system. In one embodiment, the user logs into web site 302 to a secure site. Using web site 302, user submits 402 bill pay data for processing by BPO 304. More specifically, the user enters 404 the bill pay data into web site 302 using, for example, text boxes and drop down menus. For example, to enter 404 the bill pay data, the user indicates biller 314 by selecting biller 314 from a list of payees accessible through interchange network 308 and/or RPPS 312, adds and/or confirms a biller account number, and enters a requested amount to pay biller 314 and/or a payment date on which to submit the payment to biller 314. By selecting a submit button or the like, the entered bill pay data is transmitted 406 from web site 302 to BPO 304. In the exemplary embodiment, the bill pay data transmitted 406 to BPO 304 is also transmitted to acquirer/acquirer processor 306. In an alternative embodiment, the user logs into web site 302 to a secure site and creates a schedule for automatic recurring bill payment. On the scheduled date, the bill is automatically submitted for payment.

Once the bill pay data is submitted 402 to BPO 304, authorization and approval messages are transmitted 408 between acquirer/acquirer processor 306 and issuer/issuer processor 310. More specifically, acquirer/acquirer processor 306 transmits 410 an authorization message and/or the bill pay data to interchange network 308. The authorization message requests an approval message confirming that the transaction card account includes sufficient funds to pay the bill. In the exemplary embodiment, before transmitting 410 the authorization message and/or the bill pay data, acquirer/acquirer processor 306 automatically converts 412 the authorization message and/or the bill pay data into a format to enable communication with interchange network 308. Alternatively, when the bill pay data is submitted 402 and/or the authorization message is generated in a format readable by interchange network 308, acquirer/acquirer processor 306 does not convert 412 the bill pay data and/or the authorization message. Once interchange network 308 receives the authorization message and/or the bill pay data, interchange network 308 automatically converts 414 the bill pay data and/or the authorization message into a format to enable communication with issuer/issuer processor 310, if the bill pay data and/or authorization message is not in a format readable by issuer/issuer processor 310.

Interchange network 308 then transmits 416 the authorization message to issuer/issuer processor 310. When issuer/issuer processor 310 receives the authorization message, issuer/issuer processor determines 418 if there are sufficient funds in the user's prepaid account to make the requested payment (i.e., pay the bill). If the prepaid card user does not have sufficient funds within his/her prepaid account, issuer/issuer processor 310 transmits 420 a rejection or denial message to interchange network 308 which transmits 422 the rejection or denial message to acquirer/acquirer processor 306. Acquirer/acquirer processor transmits 422 the denial message to BPO 304 and/or the prepaid user and the transaction ends 424 without paying the bill.

If the prepaid card user has sufficient funds in his/her prepaid account to cover the amount of the requested payment, issuer/issuer processor 310 reserves 426 a reserve amount within the prepaid account, wherein the reserve amount equals the bill payment amount and is reserved for paying the bill during a settlement process. Further, if the prepaid card account has sufficient funds, issuer/issuer processor 310 transmits 428 an approval message to interchange network 308, which transmits 430 the approval message to acquirer/acquirer processor 306. The approval message transmitted 430 to acquirer/acquirer processor 306 is also received by BPO 304.

When the approval message is received by acquirer/acquirer processor 306 and/or BPO 304, the bill pay data is submitted 432 to biller 314. More specifically, upon receiving the approval message, BPO 304 transmits 434 the bill pay data to RPPS 312, which transmits 436 the bill pay data to biller 314. As such, biller 314 is notified that a payment of funds to pay a bill is scheduled and/or pending. Further, after the approval message has been transmitted 432 to biller 314, funds data are transferred 438 from issuer bank 310 to biller 314 during a settlement process, such as in a batch settlement via interchange network 308 and/or RPPS 312. The funds data may be transferred 438 as soon as possible after approval or transferred 438 at a future time specified by the prepaid card user. More specifically, to transfer 438 the funds data, the settlement process is performed.

During the settlement process, interchange network 308 transfers 438 the funds data to acquirer/acquirer processor 306 and BPO 304. Alternatively, interchange network 308 or issuer/issuer processor 310 may transfer 438 the funds data to RPPS 312 or biller 314 without the funds data being routed through acquirer/acquirer processor 306 and/or BPO 304. In the exemplary embodiment, during the settlement process, after interchange network 308 transfers 440 the funds data, interchange network 308 requests funds from issuer/issuer processor 310 in the form of a credit entry to cover the funds transferred 440 to acquirer/acquirer processor 306 and/or any fees. Issuer/issuer processor 310 transfers 442 funds data associated with the reserve amount for making the bill payment to interchange network 308 by applying a debit entry to the prepaid cardholder's account and transmitting a credit entry to interchange network 308. Alternatively, issuer/issuer processor 310 transfers 442 the funds data to interchange network 308, which then transfers 440 the funds data to acquirer/acquirer processor 306.

In the exemplary embodiment, BPO 304 uses the funds data transferred 440 to acquirer/acquirer processor 306 from interchange network 308 to issue a payment to biller 314. More specifically, BPO 304 transfers 444 the funds data from an account held by acquirer/acquirer processor 306 to RPPS 312. RPPS 312 transfers 446 the funds data to biller 314 to pay the bill. As such, the credit entry is transmitted from issuer/issuer processor 310, to interchange network 308, to acquirer/acquirer processor 306, to RPPS 312, to biller 314. Alternatively, rather than transferring 444 the funds data from acquirer/acquirer processor 306 to RPPS 312 and transferring 446 the funds data from RPPS 312 to biller 314, BPO 312 issues a check to biller 314 such that biller 314 can draw funds from BPO's account held by acquirer/acquirer processor 306. In the exemplary embodiment, the settlement process includes steps 440, 442, 444, and 446.

In the embodiment described herein, the billing amount paid by the user may also include an additional cardholder fee that is retained by the interchange network or the RPPS as a processing fee for processing the payment. The system and process may also be configured to enable a user to schedule automatic recurring bill payments wherein, on the scheduled date, the bill is automatically submitted for payment by the system. In addition, the interchange network is configured to track payments submitted by different users of the system. Specifically, the interchange network is configured to track payments, award reward points, and manage reward programs and other special programs that may be offered to users by the interchange network. In other words, points may be provided to users of the system as an incentive to use the system. These points are tracked and managed by the interchange network.

The above-described embodiments facilitate enabling a prepaid transaction card user to pay a bill using a prepaid transaction card and/or a debit card. More specifically, the system described herein uses an existing interchange network to communicate between a bill payment outsourcer and an issuer bank by treating the bill payment outsourcers as a merchant. As such, the above-described system and method decrease upfront costs for the issuer bank wishing to offer bill pay to its customers, as compared to system having an integration protocol between the bill payment outsourcer and the issuer bank. More specifically, because an issuer processor and an acquirer processor are already configured to communication with an interchange network for processing credit card transactions, no other protocols are required to be developed and/or implemented between the acquirer processor and the issuer processor. Moreover, because the systems described herein do not require a specialized integration protocol, the issuer bank can change bill payment outsourcers without developing and implementing another integration protocol. Also, issuers and/or issuer processors are not responsible for upgrades to an integration protocol when the above-described system is implemented.

Additionally, the above-described systems and method decrease the number of integration protocols supported by a bill payment outsourcer. More specifically, by using the interchange network for communication with the issuer bank, the bill payment outsourcer is not required to support a separate integration protocol for each issuer/issuer processor contracting with the bill payment outsourcer. Furthermore, the interchange network described herein guarantees fund settlement with the bill payment outsourcer, which reduces the bill payment outsourcer's liability when using the system described herein.

Exemplary embodiments of methods and systems for paying bills using a prepaid transaction card are described above in detail. The methods and systems are not limited to the specific embodiments described herein, but rather, components of the systems and/or steps of the methods may be utilized independently and separately from other components and/or steps described herein. For example, the methods may also be used in combination with other bill paying systems and methods, and are not limited to practice with only the prepaid transaction card systems and methods based on transaction card purchases as described herein. Rather, the exemplary embodiment can be implemented and utilized in connection with many other bill paying applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-30. (canceled)

31. A computer-based method for enabling data exchange between first and second computing devices lacking a shared data exchange protocol, said method performed using an interchange network operating under a set of proprietary communications standards promulgated by the interchange network for the exchange of financial transaction data and settlement funds between financial institutions, said method comprising:
receiving, at the first computing device, bill pay data submitted by a consumer via a communication channel other than the interchange network, the bill pay data including data representing a billed amount to be paid to a biller and a pre-paid transaction card account associated with the consumer to be used for paying the billed amount;
generating, by an acquirer/processor module of the first computing device, an authorization message requesting authorization to pay the billed amount using funds from the pre-paid transaction account;
transmitting, from the acquirer/processor module to the second computing device via the interchange network using the set of proprietary communication standards, the authorization message;
receiving, by the acquirer/processor module from the second computing device via the interchange network using the set of proprietary communication standards, an approval message confirming that the pre-paid transaction card account includes sufficient funds to pay the billed amount; and
in response to receiving the approval message at the acquirer/processor module, forwarding, by the first computer system, the bill pay data to the biller via a remote payment system.

32. The computer-based method in accordance with claim 31, wherein receiving the bill pay data submitted by the consumer further comprises:
receiving the bill pay data from a consumer computer system, wherein the first computing device is associated with a bill payment outsourcer.

33. The computer-based method in accordance with claim 31, wherein receiving the bill pay data submitted by the consumer further comprises:
receiving the bill pay data from an interactive voice response system, wherein the first computing device is associated with a bill payment outsourcer.

34. The computer-based method in accordance with claim 31, wherein the first computing device is associated with at least one of an acquirer bank and an acquirer processor.

35. The computer-based method in accordance with claim 31, wherein the second computing device is associated with at least one of an issuing bank that issued the pre-paid transaction card to an account holder and an issuer processor that processes transactions on behalf of the issuing bank.

36. The computer-based method in accordance with claim 31, further comprising:
receiving, at the acquirer/processor module from the second computing device via the interchange network using the set of proprietary communication standards, data representing a funds transfer based on the billed amount from the pre-paid transaction card account to an account associated with the acquirer/processor module; and
transmitting, by the first computing device to the biller via the remote payment system, data representing a funds transfer based on the billed amount from the account associated with the acquirer/processor module to an account associated with the biller.

37. The computer-based method in accordance with claim 31, further comprising:
receiving, at the first computing device, second bill pay data submitted by a second consumer via the communication channel other than the interchange network, the second bill pay data including data representing a second billed amount to be paid to a second biller and a second pre-paid transaction card account associated with the second consumer to be used for paying the second billed amount, the second pre-paid transaction card account associated with a third computing device different from the second computing device;
generating, by the acquirer/processor module, a second authorization message requesting authorization to pay the second billed amount using funds from the second pre-paid transaction account;
transmitting, from the acquirer/processor module to the third computing device via the interchange network using the set of proprietary communication standards, the second authorization message;
receiving, by the acquirer/processor module from the third computing device via the interchange network using the set of proprietary communication standards, a second approval message confirming that the second pre-paid transaction card account includes sufficient funds to pay the second billed amount; and
in response to receiving the second approval message at the acquirer/processor module, forwarding, by the first computer system, the second bill pay data to the second biller via the remote payment system.

38. A first computing device enabled for data exchange with a second computing device lacking a shared data exchange protocol, said first computing device programmed to:
execute an acquirer/processor module programmed to communicate with an interchange network operating under a set of proprietary communications standards promulgated by the interchange network for the exchange of financial transaction data and settlement funds between financial institutions;
receive bill pay data submitted by a consumer via a communication channel other than the interchange network, the bill pay data including data representing a billed amount to be paid to a biller and a pre-paid transaction card account associated with the consumer to be used for paying the billed amount;
generate, by the acquirer/processor module, an authorization message requesting authorization to pay the billed amount using funds from the pre-paid transaction account;
transmit, from the acquirer/processor module to the second computing device via the interchange network using the set of proprietary communication standards, the authorization message;
receive, by the acquirer/processor module from the second computing device via the interchange network using the set of proprietary communication standards, an approval message confirming that the pre-paid transaction card account includes sufficient funds to pay the billed amount; and
in response to receiving the approval message at the acquirer/processor module, forward, the bill pay data to the biller via a remote payment system.

39. The first computing device in accordance with claim 38, further programmed to:
receive the bill pay data from a consumer computer system, wherein the first computing device is associated with a bill payment outsourcer.

40. The first computing device in accordance with claim 38, further programmed to:
receive the bill pay data from an interactive voice response system, wherein the first computing device is associated with a bill payment outsourcer.

41. The first computing device in accordance with claim 38, wherein the first computing device is associated with at least one of an acquirer bank and an acquirer processor.

42. The first computing device in accordance with claim 38, wherein the second computing device is associated with at least one of an issuing bank that issued the pre-paid transaction card to an account holder and an issuer processor that processes transactions on behalf of the issuing bank.

43. The first computing device in accordance with claim 38, further programmed to:
receive, at the acquirer/processor module from the second computing device via the interchange network using the set of proprietary communication standards, data representing a funds transfer based on the billed amount from the pre-paid transaction card account to an account associated with the acquirer/processor module; and
transmit, to the biller via the remote payment system, data representing a funds transfer based on the billed amount from the account associated with the acquirer/processor module to an account associated with the biller.

44. The first computing device in accordance with claim 38, further programmed to:
receive second bill pay data submitted by a second consumer via the communication channel other than the interchange network, the second bill pay data including data representing a second billed amount to be paid to a second biller and a second pre-paid transaction card account associated with the second consumer to be used for paying the second billed amount, the second pre-paid transaction card account associated with a third computing device different from the second computing device;
generate, by the acquirer/processor module, a second authorization message requesting authorization to pay the second billed amount using funds from the second pre-paid transaction account;
transmit, from the acquirer/processor module to the third computing device via the interchange network using the set of proprietary communication standards, the second authorization message;
receive, by the acquirer/processor module from the third computing device via the interchange network using the set of proprietary communication standards, a second approval message confirming that the second pre-paid transaction card account includes sufficient funds to pay the second billed amount; and
in response to receiving the second approval message at the acquirer/processor module, forward the second bill pay data to the second biller via the remote payment system.

45. A computer program embodied on a non-transitory computer readable medium for paying a bill using a pre-paid transaction card account, said program comprising instructions that, when executed by a first computing system, cause the first computing system to:
execute an acquirer/processor module programmed to communicate with an interchange network operating under a set of proprietary communications standards promulgated by the interchange network for the exchange of financial transaction data and settlement funds between financial institutions;
receive bill pay data submitted by a consumer via a communication channel other than the interchange network, the bill pay data including data representing a billed amount to be paid to a biller and a pre-paid transaction card account associated with the consumer to be used for paying the billed amount;
generate, by the acquirer/processor module, an authorization message requesting authorization to pay the billed amount using funds from the pre-paid transaction account;
transmit, from the acquirer/processor module to a second computing device via the interchange network using the set of proprietary communication standards, the authorization message;
receive, by the acquirer/processor module from the second computing device via the interchange network using the set of proprietary communication standards, an approval message confirming that the pre-paid transaction card account includes sufficient funds to pay the billed amount; and
in response to receiving the approval message at the acquirer/processor module, forward, the bill pay data to the biller via a remote payment system.

46. The computer program in accordance with claim 45, wherein the instructions, when executed, further cause the first computing system to:
receive the bill pay data from a consumer computer system, wherein the first computing device is associated with a bill payment outsourcer.

47. The computer program in accordance with claim 45, wherein the instructions, when executed, further cause the first computing system to:
receive the bill pay data from an interactive voice response system, wherein the first computing device is associated with a bill payment outsourcer.

48. The computer program in accordance with claim 45, wherein the second computing device is associated with at least one of an issuing bank that issued the pre-paid transaction card to an account holder and an issuer processor that processes transactions on behalf of the issuing bank.

49. The computer program in accordance with claim 45, wherein the instructions, when executed, further cause the first computing system to:
receive, at the acquirer/processor module from the second computing device via the interchange network using the set of proprietary communication standards, data representing a funds transfer based on the billed amount from the pre-paid transaction card account to an account associated with the acquirer/processor module; and
transmit, to the biller via the remote payment system, data representing a funds transfer based on the billed amount from the account associated with the acquirer/processor module to an account associated with the biller.

50. The computer program in accordance with claim 45, wherein the instructions, when executed, further cause the first computing system to:
receive second bill pay data submitted by a second consumer via the communication channel other than the interchange network, the second bill pay data including data representing a second billed amount to be paid to a second biller and a second pre-paid transaction card account associated with the second consumer to be used for paying the second billed amount, the second pre-paid transaction card account associated with a third computing device different from the second computing device;
generate, by the acquirer/processor module, a second authorization message requesting authorization to pay the second billed amount using funds from the second pre-paid transaction account;
transmit, from the acquirer/processor module to the third computing device via the interchange network using the set of proprietary communication standards, the second authorization message;
receive, by the acquirer/processor module from the third computing device via the interchange network using the set of proprietary communication standards, a second approval message confirming that the second pre-paid transaction card account includes sufficient funds to pay the second billed amount; and
in response to receiving the second approval message at the acquirer/processor module, forward the second bill pay data to the second biller via the remote payment system.
